(19) United States
(12) Patent Application Publication
(10) Pub. No.: US 2015/0146440 A1
(43) Pub. Date: May 28, 2015

(54) AUTOMOTIVE HEAD LAMP

(71) Applicant: HYUNDAI MOBIS CO., LTD., Seoul (KR)

(72) Inventors: Hyuk Min LEE, Yongin-si (KR); Hyun Soo LEE, Yongin-si (KR); In Heum PARK, Yongin-si (KR); Myoung Guk BANG, Yongin-si (KR)

(73) Assignee: HYUNDAI MOBIS CO., LTD., Seoul (KR)

(21) Appl. No.: 14/139,689

(22) Filed: Dec. 23, 2013

(30) Foreign Application Priority Data
Nov. 28, 2013 (KR) 10-2013-0145995

(51) Int. Cl. B60Q 1/08

(52) U.S. Cl. CPC B60Q 1/085
USPC 362/465

(57) ABSTRACT

Disclosed is an automotive head lamp, including: a fixed lamp module including a first lamp unit and a second lamp unit; a rotating lamp module including a third lamp unit and a fourth lamp unit; and a control unit configured to control a driving of the fixed lamp module and the rotating lamp module, in which the rotating lamp module is disposed closely to a side of a vehicle than the fixed lamp module.

### CROSS-REFERENCE TO RELATED APPLICATIONS

This application claims priority to and the benefit of Korean Patent Application No. 10-2013-0145995 filed in the Korean Intellectual Property Office on Nov. 28, 2013, the entire contents of which are incorporated herein by reference.

### TECHNICAL FIELD

The present invention relates to an automotive head lamp.

### BACKGROUND ART

An automotive lamp is generally divided into a head lamp which is installed at a front of a vehicle and a tail lamp which is installed at a rear of the vehicle. Head lamps are installed at both sides of a front of a vehicle so that a driver may secure a field of vision in a driving direction while driving at night.

Recently, the head lamp is configured to move vertically or horizontally depending on a driving environment.

For example, when a vehicle is driven along a curved road, the head lamp rotates in a driving direction to be able to help a driver secure a field of vision. Meanwhile, it is also possible to prevent blinding a driver of an oncoming vehicle due to glare of the light by blocking a portion of an irradiation area of a high beam depending on a position of the oncoming vehicle in the opposite direction.

The overall module configuring the head lamp rotates when the head lamp rotates. In this case, illumination is changed near a vehicle, which may lead to confusion in a driver's field of vision.

### SUMMARY OF THE INVENTION

The present invention has been made in an effort to provide an automotive head lamp capable of maintaining near-field illumination while preventing blinding a driver of an oncoming vehicle due to glare of the light.

An exemplary embodiment of the present invention provides an automotive head lamp, including: a fixed lamp module including a first lamp unit and a second lamp unit; a rotating lamp module including a third lamp unit and a fourth lamp unit; and a control unit configured to control a driving of the fixed lamp module and the rotating lamp module, in which the rotating lamp module may be disposed more closely to a side of a vehicle than the fixed lamp module.

The first lamp unit may generate a high pattern and the second lamp unit may generate a low wide pattern.

The third lamp unit may include an adaptive driving beam (ADB) lamp unit.

The third lamp unit may generate an L-shape pattern. The fourth lamp unit may include a dynamic bending light (DBL) lamp unit.

The fourth lamp unit may generate a low focus pattern.

The automotive head lamp may further include: a rotation driving unit configured to rotate the rotating lamp module.

The third lamp unit and the fourth lamp unit may each rotate by the rotation driving unit.

According to the automotive head lamp according to the exemplary embodiments of the present invention and the vehicle including the same, it is possible to maintain the near-field illumination while preventing blinding a driver of an oncoming vehicle due to glare of the light.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram illustrating an automotive head lamp according to an exemplary embodiment of the present invention.

FIG. 2 is a graph illustrating a case in which a beam pattern implemented by the automotive head lamp of FIG. 1 is a low beam.

FIG. 3 is a graph illustrating a case in which the beam pattern implemented by the automotive head lamp of FIG. 1 is a high beam.

FIG. 4 is a graph illustrating a case in which the beam pattern implemented by the automotive head lamp of FIG. 1 is a DBL and an ADB.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. Hereinafter, substantially the same components are each denoted by like reference numerals in the following description and the accompanying drawings and therefore, a repeated description thereof will be omitted. In describing exemplary embodiments of the present invention, when it is determined that the detailed description of the known function or configuration related to the present invention may obscure the gist of the present invention, the detailed description thereof will be omitted.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without another element intervening therebetween.

Unless explicitly described to the contrary, a singular form includes a plural form in the present specification. The word “comprise” and variations such as “comprises” or “comprising” used in the specification will be understood to imply the inclusion of stated elements, steps, operations and/or elements but not the exclusion of any other elements, steps, operations and/or elements.

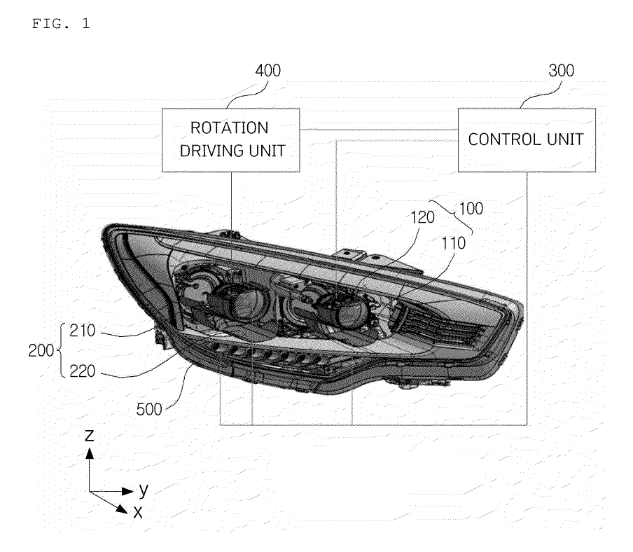

FIG. 1 is a configuration diagram illustrating an automotive head lamp according to an exemplary embodiment of the present invention.

Referring to FIG. 1, an automotive head lamp according to an exemplary embodiment of the present invention includes a fixed lamp module 100, a rotating lamp module 200, a control unit 300, and a rotation driving unit 400.

The fixed lamp module 100 is fixed to an inside (right in FIG. 1) of a lamp housing 500. The fixed lamp module 100 includes a first lamp unit 110 and a second lamp unit 120.

The first lamp unit 110 may illuminate the far field in front of a vehicle and generate a high pattern. The first lamp unit 110 may include a light emitting diode (LED) as a light source.

The second lamp unit 120 is disposed over the first lamp unit 110. The second lamp unit 120 may illuminate the near field in front of a vehicle and generate a low wide pattern. The second lamp unit 120 may include a light emitting diode (LED) as a light source.

The rotating lamp module 200 is provided at an outside (left in FIG. 1) of the lamp housing 500. That is, the rotating lamp module 200 is disposed more closely to a side of a vehicle than the fixed lamp module 100.

The rotating lamp module 200 may rotate in a width direction (based on a Z axis in FIG. 1) of the vehicle depending on a control of the rotation driving unit 400 (swivel actuator) to be described below. Meanwhile, the rotating lamp module 200 includes a third lamp unit 210 and a fourth lamp unit 220, such that the third lamp unit 210 and the fourth lamp unit 220 may rotate in the width direction of the vehicle individually or together.

The third lamp unit 210 includes an adaptive driving beam (ADB) lamp unit. The third lamp unit 210 may illuminate the long range in front of the vehicle and generate an L-shape pattern. Therefore, it is possible to prevent blinding a driver of an oncoming vehicle in an opposite vehicle path due to glare of the light by controlling brightness of light emitted from the third lamp unit 210 or blocking light of a specific area. The third lamp unit 210 moves along a moving path of the oncoming vehicle, such that it is possible to more effectively prevent blinding a driver of an oncoming vehicle due to glare of the light. Meanwhile, the third lamp unit 210 may include the light emitting diode (LED) as the light source.

The fourth lamp unit 220 is disposed over the third lamp unit 210 and includes a dynamic bending light (DBL) lamp unit. The fourth lamp unit 220 may illuminate the long range in front of the vehicle and generate a low focus pattern. Therefore, when a vehicle is driven along a curved road, the fourth lamp unit 220 rotates toward a curved direction of a road, such that it is possible to help a driver secure a field of vision in the short range in front of the vehicle. Meanwhile, the fourth lamp unit 220 may include the light emitting diode (LED) as the light source.

The control unit 300 controls the driving of the fixed lamp module 100 and the rotating lamp module 200 to implement a required beam pattern depending on a driving condition. Examples of the required beam pattern may include a low beam, a high beam, the DBL, and the ADB. In order to implement the beam pattern, the first to fourth lamp units 110, 120, 210, and 220 of the fixed lamp module 100 and the rotating lamp module 200 may be individually turned on or off depending on the signal from the control unit 300.

Meanwhile, the control unit 300 also controls the rotation driving unit 400. The rotation driving unit 400 rotates the rotating lamp module 200 to implement the ADB and DBL beam patterns. The rotation driving unit 400 may include a linear motor and a power transmission module. The third lamp unit 210 and the fourth lamp unit 220 are connected to the power transmission module, thereby rotating by s linear motor.

As described above, the turning on/off of the first to fourth lamp units 110, 120, 210, and 220 and the rotation of the third lamp unit 210 and the fourth lamp unit 220 are combined with each other, thereby implementing the required beam pattern.

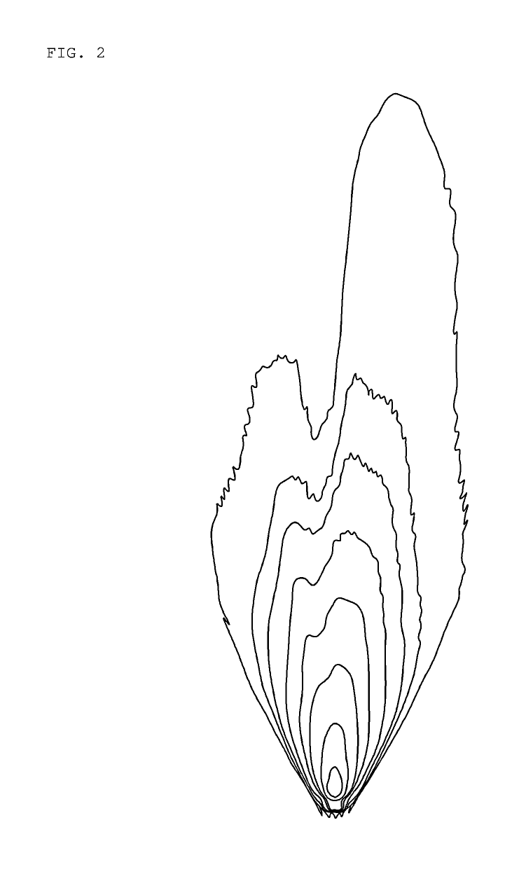

As illustrated in FIG. 2, when the required beam pattern is the low beam, only the second and fourth lamp units 120 and 220 are turned on. In this case, since the head lamp irradiates the short range in front of the vehicle, a road surface pattern as illustrated in FIG. 2 may be obtained.

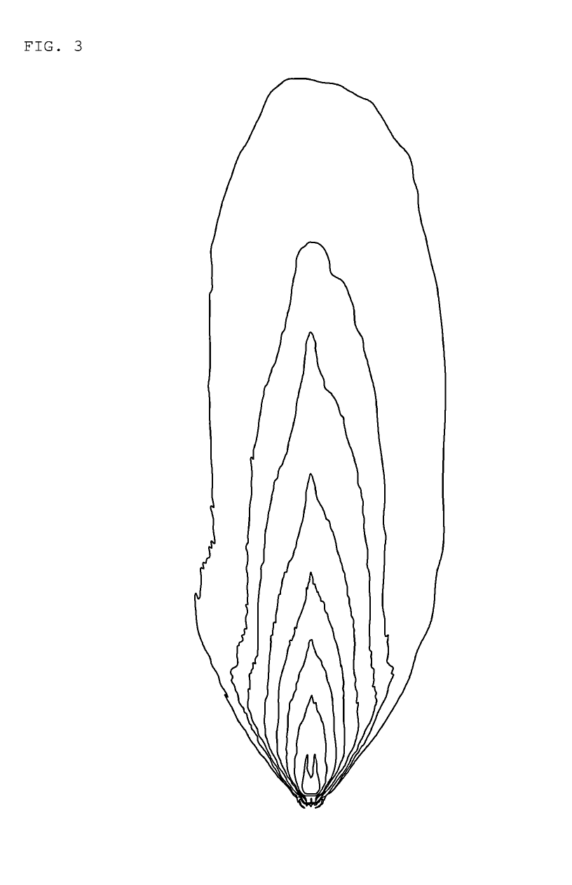

As illustrated in FIG. 3, when the required beam pattern is the high beam, all the first to fourth lamp units 110, 120, 210, and 220 are turned on. In this case, since the head lamp irradiates both of the long and short ranges in front of the vehicle, a road surface pattern as illustrated in FIG. 3 may be obtained.

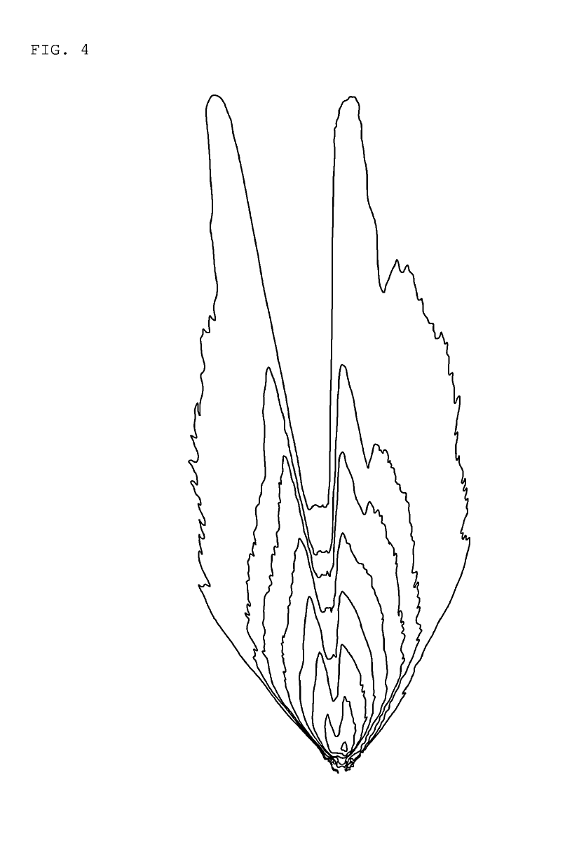

As illustrated in FIG. 4, when the required beam pattern is the DBL and the ADB, the second to fourth lamp units 120, 210, and 220 are turned on. In this case, since the head lamp irradiates both of the long and short ranges in front of the vehicle, a road surface pattern as illustrated in FIG. 4 may be obtained. Meanwhile, if necessary, the second lamp unit 120 may vertically move (leveling) or the second lamp unit 120 may be turned off.

As described above, according to the exemplary embodiment of the present invention, the turning on/off of the first to fourth lamp units 110, 120, 210, and 220 and the rotation of the third lamp unit 210 and the fourth lamp unit 220 are combined with each other, thereby implementing various beam patterns.

Meanwhile, according to the exemplary embodiment of the present invention, the third lamp unit 210 and the fourth lamp unit 220 may rotate by being connected to one rotation driving unit 400. In this case, as compared with the case in which each lamp unit includes a rotation driving unit, the number of components is reduced, and thus costs may be saved as much.

On the other hand, according to the exemplary embodiment of the present invention, even though the third lamp unit 210 rotates, the second lamp unit is fixed, and therefore a driver of a vehicle may stably secure the field of vision of the short range.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. An automotive head lamp, comprising:
a fixed lamp module including a first lamp unit and a second lamp unit;
a rotating lamp module including a third lamp unit and a fourth lamp unit; and
a control unit configured to control a driving of the fixed lamp module and the rotating lamp module,
wherein the rotating lamp module is disposed more closely to a side of a vehicle than the fixed lamp module.

2. The automotive head lamp of claim 1, wherein the first lamp unit generates a high pattern and the second lamp unit generates a low wide pattern.

3. The automotive head lamp of claim 1, wherein the third lamp unit includes an adaptive driving beam (ADB) lamp unit.

4. The automotive head lamp of claim 3, wherein the third lamp unit generates an L-shape pattern.

5. The automotive head lamp of claim 3, wherein the fourth lamp unit includes a dynamic bending light (DBL) lamp unit.

6. The automotive head lamp of claim 5, wherein the fourth lamp unit generates a low focus pattern.

7. The automotive head lamp of claim 1, further comprising: a rotation driving unit configured to rotate the rotating lamp module.

8. The automotive head lamp of claim 7, wherein the third lamp unit and the fourth lamp unit is each rotatable by the rotation driving unit.

9. The automotive head lamp of claim 4, wherein the fourth lamp unit includes a dynamic bending light (DBL) lamp unit.

10. The automotive head lamp of claim 9, wherein the fourth lamp unit generates a low focus pattern.
